(19) United States
(12) Patent Application Publication
(10) Pub. No.: US 2008/0219689 A1
(43) Pub. Date: Sep. 11, 2008

(54) SELECTABLE MICR SYSTEM AND METHOD

(75) Inventors: Joseph H. Lang, Webster, NY (US); Mark S. Amico, Pittsford, NY (US)

Correspondence Address: OLIFF & BERRIDGE, PLC., P.O. BOX 320850, ALEXANDRIA, VA, 22320-4850, US

(73) Assignee: XEROX CORPORATION, Stamford, CT (US)

(21) Appl. No.: 11/682,657

(22) Filed: Mar. 6, 2007

(51) Int. Cl. G03G 15/00

(52) U.S. Cl. 399/81; 399/82

(57) ABSTRACT

A method of generating a printed document from a marking device that includes two or more developer units, where at least one of the developer units contains a magnetic ink character recognition (MICR) toner and where at least one other of the developer units contains a non-MICR toner. The method includes receiving a request to print a document where the request to print the document includes information on whether the document is to be printed using MICR toner or non-MICR toner, and printing the document using the unit containing the desired toner.

### BACKGROUND

The present disclosure is related to a method of makings an image, and an apparatus of a marking device that includes two or more developer units. In particular, a marking device is provided where at least one developer unit contains magnetic ink character recognition (MICR) toner and at least one developer unit contains non-MICR toner. The marking device is capable of providing MICR images and/or non-MICR images.

The process of digital printing/copying involves sensitizing the surface of a photoconductive member by charging to a substantially uniform potential. The charged portion of the photoconductive surface is exposed to a light image that selectively discharges portions of the surface thereby recording the image of the document. Alternatively, a modulated light beam, for example a laser beam, may be utilized to discharge the photoconductive surface to record the desired information. In this way, a latent image is recorded on the photoconductive surface. The image corresponds to the information desired to be reproduced. After the image is recorded on the photoconductive member, it may be developed by contact with developer material. The developer material may comprise toner particles adhering triboelectrically to carrier granules, or alternatively a single component development system may be employed. The toner particles are transferred from the carrier granules to the latent image to form a toner powder image on the photoconductive surface, which is subsequently transferred to an image receiving substrate such as a copy sheet, and then heated to permanently affix the powder image.

Digital printing/copying is useful for producing checks or financial documents with magnetic characters for the banking industry and for other businesses producing financial instruments. The process involves fusing magnetic toner particles on the checks or documents to provide an image encoded with magnetic ink character recognition (MICR), which is a character recognition technology adopted mainly by the banking industry for the automated reading and sorting of checks and negotiable instruments, as well as for other documents in need of high speed reading and sorting.

MICR toner is typically comprised of a mixture of a fine metallic powder with toner binder and colorant, such as polyester resin and powdered dye. This magnetically detectable toner is used to print MICR characters that encode account numbers on documents, for example turn around documents such as invoice statements like those submitted to customers by American Express and VISA. corporate checks, highway tickets, rebate checks, and other documents with magnetic codes thereon to be recognized magnetically by devices such as reader/sorters. These digital characters, usually on the bottom edge of a paper check, are used to indicate, for example the payor financial institution, payor account number, and/or the instrument number on the payment instrument.

In some conventional marking devices that utilize MICR toner, the marking device is a MICR-dedicated printer, that is, a printer that prints only with MICR toner. However, most users that need a marking device that utilizes MICR toner only need MICR toner on about 40% of the print jobs, and even documents that are in need of MICR toner may only need MICR toner on a portion of the document. For example, even though only a portion of a document is in need of MICR toner, e.g., only the digital characters at the bottom edge of a check, the entire document is printed with MICR toner. This creates unnecessary expense to the user since MICR toner is more costly compared to standard non-magnetic toners.

Other conventional marking devices that utilize MICR toner use a two pass system where one pass is performed on a marking device dedicated to the printing of MICR characters and another pass is performed on a separate marking device used to print the non-MICR aspects of the document. However, this process is not only time consuming, it requires more than one marking device.

In other conventional marking devices, the device allows a user to physically switch out developer devices, for example the developer unit and toner, in a single developer unit so that the user can switch between a MICR toner (when a MICR unit is inserted) and standard toner (when a non-MICR unit is inserted). While this allows a user to choose what type of toner to use to print a certain document, the user must physically remove one developer unit and toner dispenser and replace it with the desired developer unit and toner dispenser. This method is not only labor intensive and time consuming, but requires a user that knows how to install and uninstall the developer units.

### SUMMARY

What is needed is a marking device that contains two or more developer units where at least one developer unit contains magnetic ink character recognition (MICR) toner and at least one other developer unit contains non-MICR toner.

In embodiments, described is a method of generating a printed document from a marking device that includes two or more developer units, wherein at least one of the developer units contains MICR toner and wherein at least one other of the developer units contains non-MICR toner, comprising receiving a request to print a document, wherein the request to print the document includes information on whether the document is to be printed using MICR toner or non-MICR toner, and printing the document using the unit containing the desired toner.

In further embodiments, described is a method of generating a printed document from a marking device that includes two or more developer units, wherein at least one of the developer units contains MICR toner and wherein at least one other of the developer units contains non-MICR toner, comprising receiving a request to print a document, determining the developer unit needed to print each portion of the document, and printing the document using the unit containing the desired toner, and wherein the request to print the document includes information on whether the document is to be printed using MICR toner or non-MICR toner.

In still further embodiments, described is an apparatus for generating printed documents, comprising a photoreceptor, a first developer unit containing a MICR toner, and a second developer unit containing non-MICR toner.

The methods and apparatus herein thus have utility in reducing the cost and time for printing documents that contain MICR toner and/or non-MICR toner portions.

### BRIEF DESCRIPTION OF THE DRAWINGS

FIG. 1 is a diagram showing the basic elements of a marking device in accordance with the present disclosure.

FIG. 2 is a sectional view of a SCMB developer unit in accordance with the present disclosure.

FIG. 3 is a flow chart of a method for printing a document based on a toner selected by a user.

FIG. 4 is a flow chart of a method for printing a document based on a user request.

### EMBODIMENTS

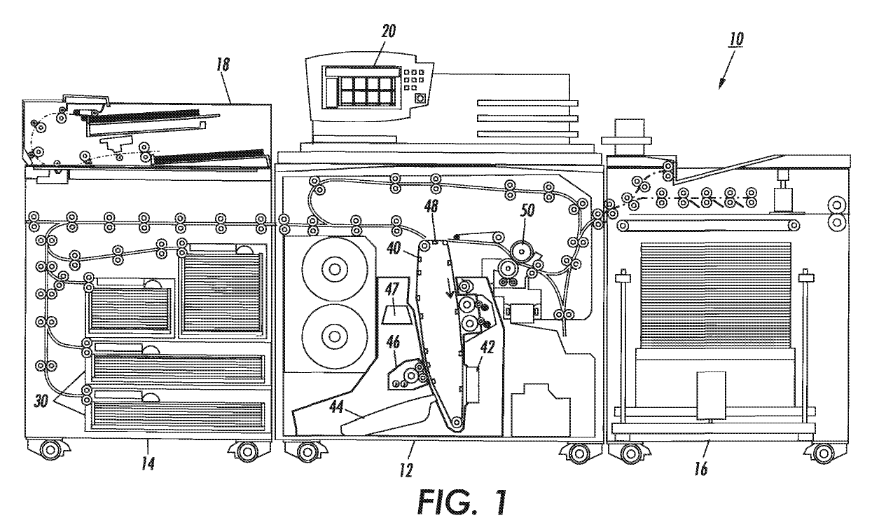

FIG. 1 is a diagram showing the basic elements of a marking device in accordance with the present disclosure. Although a xerographic, monochrome “laser printer” is shown, it will be understood that the present disclosure can be applied to any type of digital printing apparatus, including printing, xerographic, ionographic or ink jet printers as well as color or monochrome capable apparatus.

In embodiments, a device 10 includes a marking engine 12, which includes hardware by which image signals are used to create a desired image, as well as a feeder module 14, which stores and dispenses sheets on which images are to be printed, and an optional finisher 16, which may include hardware for stacking, folding, stapling and binding prints which are output from the marking engine. If the device 10 is also operable as a copier, the device further includes a document feeder 18, which operates to feed a document with an original image to an imaging station, e.g., with a platen, where the original image is converted into digital signals, which are in turn processed to create copies with the marking engine 12. The device 10 may also include a local user interface 20 for controlling its operations, although another source of image data and instructions may include any number of computers to which the device is connected via a network.

With reference to feeder module 14, the module includes any number of trays 30, each of which stores print sheets (“stock”) of a predetermined type, such as size, weight, color, coating, transparency, and includes a feeder to dispense one of the sheets therein as instructed. Certain types of stock may require special handling in order to be dispensed properly. For example, heavier or larger stocks may desirably be drawn from a stack by use of an air knife, fluffer, vacuum grip or other application (not shown) of air pressure toward the top sheet or sheets in a stack. Certain types of coated stock are advantageously drawn from a stack by the use of an application of heat, such as by a stream of hot air (not shown). Sheets drawn from a selected tray 30 are then moved to the marking engine 12 to receive one or more images thereon.

In embodiments, marking engine 12 is a monochrome type, and specifically for forming black images, although engines for making color images may also be used. A monochrome type engine uses a single color in a single developer unit, whereas a color type engine uses different colors in multiple developer units, e.g., cyan, magenta, yellow and black. In FIG. 1, marking engine 12 is shown as a monochrome device, and includes a monochrome type developer unit for MICR toner and a monochrome type developer unit that is non-MICR. The marking engine 12 also includes a photoreceptor 40, here in the form of a rotatable belt. The photoreceptor 40 is an example of what can be called a “rotatable image receptor,” meaning any rotatable structure such as a drum or belt which can temporarily retain one or more latent and/or developer images for printing may be used. The photoreceptor 40 is entrained on a number of rollers, and a number of stations familiar in the art of xerography may be placed suitably around the photoreceptor 40, such as charging station 42, imaging station 44, transfer station 48 and developer units 46 and 47, wherein one of developer units 46 and 47 contain magnetic ink recognition (MICR) toner while the other developer unit contains non-magnetic (non-MICR) toner, such as standard black toner. In embodiments, more than two developer units may be utilized where the non-MICR developer units contain color toner, for example developer units that contain cyan, yellow, magenta, black (CYMK) non-MICR toner. In further embodiments, a full process color engine with MICR may be utilized containing five developer units, where the developer units contain CYMK and MICR. In still further embodiments, three, four or five developer units may be utilized where the three, four or five developer units contain, for example, black toner, MICR toner and a one spot color system; black toner, MICR toner and a two spot color system; or black toner, MICR toner and a three spot color system, respectively.

As mentioned above, most users that need a marking device that utilizes MICR toner only need MICR toner on about 40% of the print jobs, and even documents that are in need of MICR toner may only need MICR toner on a portion of the document. The present apparatus allows a user to decide which toner is to be used to print a document, and allows a user to simultaneously print with both MICR and non-MICR toner without the need of manually switching the developer units, and without the need of two printers where one printer is dedicated to print with MICR toner and the other without non-MICR toner. Thus, time is saved because the user does not have to physically switch the developer units in order to print with a desired toner, and further the apparatus of the current disclosure reduces the number of devices needed to print with MICR toner and non-MICR toner, which reduces cost and maintenance needed to maintain more than one device.

In embodiments, developer units 46 and 47 contain a semiconductive magnetic brush (“SCMB”) apparatus, which is described further below. However, the methods and techniques described herein can be used with any suitable development system besides SCMB. Examples of other development systems include hybrid scavengeless development, hybrid jumping development, and standard magnetic brush development.

In embodiments, the non-MICR toner in one of developer units 46 and 47 may desirably be an emulsion aggregation (EA) toner, for example composed of an EA polyester binder and colorant, which EA toners are well known in the art. The MICR toner may also be an EA toner but including a magnetic component therein. Of course, the MICR toner need not be an EA toner, and any MICR toner may be used.

As mentioned above, MICR toner is a character recognition technology adopted mainly by the banking industry for the automated reading and sorting of negotiable instruments and other documents in need of high speed reading and sorting. As mentioned, MICR toner is typically comprised of a mixture of a fine metallic powder with toner binder and colorant, such as polyester resin and powdered dye. This magnetically detectable toner is used to print MICR characters that encode account numbers on documents to be recognized magnetically by devices such as reader/sorters. These digital characters are used to indicate, for example the payor financial institution, payor account number, and/or the instrument number on the payment instrument.

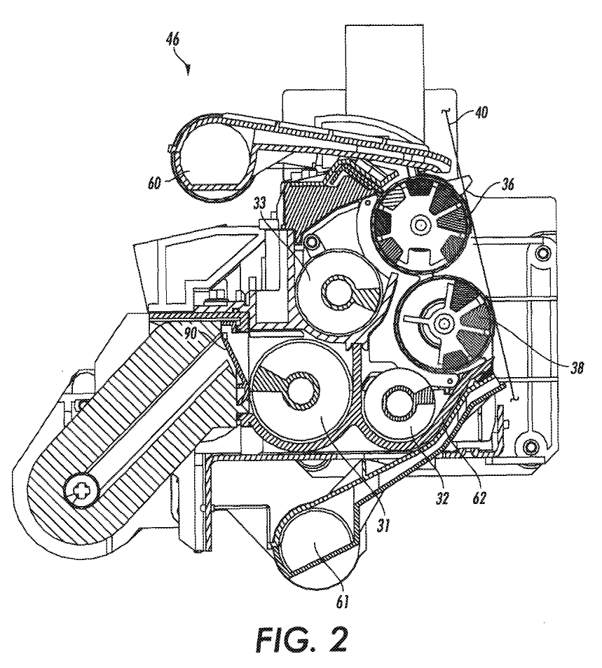

In embodiments, a two-component developer is utilized for either MICR or non-MICR toner, or for both. A two-component developer material is comprised of toner and carrier. The carrier particles in a two-component developer are generally not applied to the photoreceptor 40, but rather remain circulating within the housing 62 (See FIG. 2). However, while some carrier particles at the ends of a magnetic brush do contact the photoreceptor, these carrier particles do not remain on the photoreceptor and are therefore not developed onto the photoreceptor.

Imaging station 44 may be in the form of a laser-based raster output scanner, of a design familiar in the art of “laser printing,” in which a narrow laser beam scans successive scan lines oriented perpendicular to the process direction of the rotating photoreceptor 40. The laser is turned on and off to selectably discharge small areas on the moving photoreceptor 40 according to image data to yield an electrostatic latent image, which is developed with toner at development units 46 and 47 and transferred to a sheet at transfer station 48.

A sheet having received an image in this way is subsequently moved through a fuser 50, of a general design known in the art, and the heat and pressure from the fuser causes the toner image to become substantially permanent on the sheet. For duplex or two-sided printing, the printed sheet can then be inverted and re-fed past the transfer station 48 to receive a second-side image.

The finally-printed sheet may then be moved to an optimal finisher module 16, where it may be collated, stapled, folded, etc., with other sheets in manners familiar in the art.

A sectional view of a SCMB developer unit 46 is shown in FIG. 2. The overall function of developer unit 46 is to hold a supply of developer material having semiconductive carrier particles, as well as augers, such as 31, 32 and 33, which variously mix and convey the developer material, and magnetic rolls 36, 38, which in embodiments form magnetic brushes to apply developer material to the photoreceptor 40. Other types of features for development of latent images, such as donor rolls, paddles, scavengeless-development electrodes, commutators, etc., are known in the art and may be used in conjunction with various embodiments. In the illustrated embodiment, there is farther provided air manifolds 60 and 61, attached to vacuum sources (not shown) for removing dirt and excess particles from the transfer zone near photoreceptor 40.

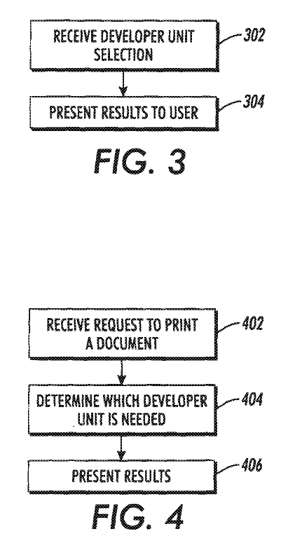

A flow chart of a method for printing a document based on a toner selected by a user is shown in FIG. 3. The method includes receiving a developer unit selection (block 302) from a user. In embodiments, the user selects a type of toner that is to be used for a print job. In further embodiments, the user selects a developer unit that is to be used for the print job. The selection of either a type of toner or developer unit may be achieved using the user interface 20. As previously mentioned, most users that need a marking device that utilizes MICR toner only need MICR on about 40% of the print jobs. hi embodiments, there are two or more developer units wherein at least one developer unit contains MICR toner and at least one other developer unit contains non-MICR toner. Thus, when the user determines which toner, MICR or non-MICR, to use for printing and at block 302, the selection is received by device 10. Once the type of toner is selected, device 10 applies the appropriate inputs and timings to the appropriate developer unit through known control mechanisms to produce the desired print. Device 10 proceeds with the request and presents the results to the user at block 304. In embodiments, the user is presented with a paper copy of the print request. In further embodiments, the results are presented on a display, for example a monitor, before the print job is performed.

A flow chart of a method for printing a document based on a user request is shown in FIG. 4. The method includes receiving a request to print a document (block 402). Upon receiving the request, at block 404, a determination is made as to which developer unit is needed to print each portion of the document. For example, if a user is printing a check where MICR toner is only needed for printing MICR characters (special numbers or bar codes) at the bottom of the check, the system will recognize that MICR toner is only needed for the bar code, while the other information on the check, for example, a name of a bank or the amount of money being transferred, will be printed using non-magnetic toner.

In embodiments, a two-pass process for printing a document with MICR toner and non-MICR toner is utilized. In a two-pass process, MICR image is developed on a first pass by, for example, using developer unit 46. The location of a portion of the document where the MICR toner is to be applied is first identified by, for example, device 10. The MICR image is then transferred to the document in the proper location, fused and returned (second pass) to the transfer point to receive non-MICR toner, for example, using developer unit 47. The return may be achieved through use of known duplex paths, the document with the MICR image entering the duplex path after fusing. The MICR and non-MICR toner print is then fused and exits from device 10. Developing the MICR image first allows the MICR image to be fused twice for superior image permanence.

In further embodiments, one-pass processes may be utilized in applying MICR and non-MICR toner. For example, using tri-level xerography, the location of the portion of the document where the MICR toner should be applied is first identified by, for example, by device 10. The MICR toner and non-MICR toner are then transferred and fused to the document simultaneously, for example, using developer units 46 and 47. Because the MICR toner is magnetic, care must be taken in one-pass processes to avoid contamination of other developer units with MICR toner.

Another one-pass process that may be utilized by the present disclosure is printing an entire page with either MICR or non-MICR toner. For example, in a print job that contains 10 pages, and pages 9 and 10 contain characters that need MICR toner, a one-pass process will allow a user to print pages 1-8 with all non-MICR toner, and to print pages 9 and 10 with all MICR toner, each page only requiring a single pass through the development section of the device

At block 406, the results of the request are presented to the user. In embodiments, the user is presented with a paper copy of the print request. In further embodiments, the results are presented on a display, for example a monitor, before the print job is performed.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

1. A method of generating a printed document from a marking device that includes two or more developer units, wherein at least one of the developer units contains magnetic ink character recognition (MICR) toner and wherein at least one other of the developer units contains non-MICR toner, comprising:
receiving a request to print a document;
wherein the request to print the document includes information on whether the document is to be printed using MICR toner or non-MICR toner; and
printing the document using the unit containing the desired toner.

2. The method of claim 1, further comprising forming a latent image on a charge retentive surface with subsequent rendering of the visible image with an application of the desired toner.

3. The method of claim 2, wherein the rendering of the visible image comprises moving the charge retentive surface past at least two of the two or more developer units in a single pass of the charge retentive surface.

4. The method of claim 1, wherein the at least one non-MICR toner is a black toner.

5. The method of claim 4, wherein the non-MICR toner is an emulsion aggregation toner.

6. The method of claim 1, wherein the non-MICR toner developer units comprise four developer units, one for each of cyan, magenta, yellow and black developer.

7. (canceled)

8. The method of claim 1, wherein the at least two or more developer units are semi-conductive magnetic brush developer units.

9. A method of generating a printed document from a marking device that includes two or more developer units, wherein at least one of the developer units contains magnetic ink character recognition (MICR) toner and wherein at least one other of the developer units contains non-MICR toner, comprising:
receiving a request to print a document;
determining the developer unit needed to print each portion of the document: and
printing the document using the unit containing the desired toner; and
wherein the request to print the document includes information on whether the document is to be printed using MICR toner or non-MICR toner.

10. The method of claim 9, further comprising forming a latent image on a charge retentive surface with subsequent rendering of a visible image with an application of toner.

11. The method of claim 10, wherein the rendering of the visible image comprises moving the charge retentive surface past at least two of the two or more developer units in a single pass of the charge retentive surface.

12. The method of claim 9, wherein determing the developer unit needed for each portion of the document is based upon the request.

13. The method of claim 9, wherein the at least one non-MICR toner is a black toner.

14. The method of claim 13, wherein the non-MICR toner is an emulsion aggregation toner.

15. The method of claim 9, wherein the at least two or more developer units are semi-conductive magnetic brush developer units.

16. The method of claim 15, wherein the at least one MICR toner is a toner comprised of binder, colorant and magnetic particles.

17. The method of claim 9, wherein the non-MICR toner is a cyan, magenta, yellow or black toner.

18. The method of claim 9, wherein the printing comprises a two-pass printing process wherein the document is made to pass twice by the developer units, comprising:
developing a MICR toner portion of the document in one of the two passes; and
developing a non-MICR toner portion of the document in the other of the two passes.

19. An apparatus for generating printed documents; comprising:
a photoreceptor; and
a developer station, wherein the development station includes a first developer unit containing a magnetic ink character recognition (MICR) toner; and
a second developer unit containing non-MICR toner.

20. The apparatus of claim 19, wherein each developer unit is a semi-conductive magnetic brush developer unit.

21. The apparatus of claim 19, wherein the non-MICR toner is an emulsion aggregation toner.
